(19) United States
(12) Patent Application Publication
(10) Pub. No.: US 2026/0219676 A1
(43) Pub. Date: Jul. 30, 2026

(54) AUTONOMOUS MOBILE BODY AND METHOD PERFORMED BY AUTONOMOUS MOBILE BODY

(71) Applicant: Panasonic Intellectual Property Management Co., Ltd., Osaka (JP)

(72) Inventor: Tatsuo SAKAI, Osaka (JP)

(21) Appl. No.: 19/459,916

(22) Filed: Jan. 26, 2026

(30) Foreign Application Priority Data
Jan. 29, 2025 (JP) 2025-013343

(51) Int. Cl. G05D 1/622; G05D 1/24; G05D 1/646; G05D 109/10; G05D 111/10; G05D 111/50

(52) U.S. Cl. CPC G05D 1/622; G05D 1/24; G05D 1/646; G05D 2109/10; G05D 2111/17; G05D 2111/54

(57) ABSTRACT

An autonomous mobile body includes a controller. The controller includes a collision avoider, and in a case where a no-entry region for the autonomous mobile body is not present on a navigation path from the current position to a first target position, when an environmental object is detected while the autonomous mobile body is moving on the navigation path, the collision avoider stops movement in a direction in which the autonomous mobile body possibly collides with the environmental object and rotation that changes a travel direction. When the collision avoider stops the movement and/or the rotation, the controller generates a second target position in a direction in which the autonomous mobile body is able to move from the current position, and controls the move mechanism to cause the autonomous mobile body to move to the first target position after moving from the current position to the second target position.

### CROSS REFERENCE TO RELATED APPLICATION

The present application is based on and claims priority of Japanese Patent Application No. 2025-013343 filed on January 29, 2025. The entire disclosure of the above-identified application, including the specification, drawings and claims is incorporated herein by reference in its entirety.

### FIELD

The present disclosure relates to an autonomous mobile body that can autonomously travel.

### BACKGROUND

Conventionally, various techniques for operating autonomous mobile bodies (that is, mobility devices) that can autonomously travel, such as delivery robots, cleaning robots, security robots, and facility guide robots, in buildings where people are present (refer to Patent Literature (PTL) 1, for example).

PTL 1 has proposed an autonomous mobile body that generates a navigation path from the current position of the autonomous mobile body to a preset final target position of the autonomous mobile body to be able to travel from the current position to the final target position. Specifically, the autonomous mobile body successively generates a first target position on the generated navigation path and tracks the generated first target positions, to be able to move from the current position to the final target position.

### CITATION LIST

### PATENT LITERATURE

PTL 1: Japanese Patent No. 3844247

### SUMMARY

### Technical Problem

However, the autonomous mobile body may not be able to move from the current position to the final target position with the technology of PTL 1. For example, when a first target position is generated on a navigation path and a no-entry region for the autonomous mobile body is not present on a navigation path from the current position of the autonomous mobile body to the first target position, the autonomous mobile body starts moving to the first target position. When the autonomous mobile body starts moving to the first target position, in situations where rotation that changes the travel direction is necessary in order to move to the first target position, in a case where an environmental object such as a wall is present in the vicinity of the autonomous mobile body although a no-entry region for the autonomous mobile body is not present on the navigation path from the current position of the autonomous mobile body to the first target position, it is necessary to stop the rotation in order to avoid collision with the wall, for instance. However, when the first target position is not located, due to the stopping of the rotation, on a straight-line course with reference to the travel direction of the autonomous mobile body, the autonomous mobile body may not be able to move to the first target position. Thus, even when first target position is generated on a navigation path and a no-entry region for the autonomous mobile body is not present on a navigation path from the current position of the autonomous mobile body to the first target position, the autonomous mobile body cannot move to the first target position or rotate to change the travel direction, and may become immovable.

In view of this, the present disclosure provides, for instance, an autonomous mobile body that can move from the current position to the final target position even when an environment in which the autonomous mobile body travels is complicated.

### Solution to Problem

In order to provide such an autonomous mobile body, an autonomous mobile body according to an aspect of the present disclosure is an autonomous mobile body that includes a move mechanism, the autonomous mobile body including: a sensor that obtains position information of an environmental object present in vicinity of the autonomous mobile body; and a controller that, based on the position information obtained, successively generates a first target position on a navigation path from a current position of the autonomous mobile body to a final target position to result in successively generated first target positions, and controls the move mechanism to cause the autonomous mobile body to reach the final target position by tracking the successively generated first target positions. The controller includes a collision avoider. In a case where, based on the position information obtained, a no-entry region for the autonomous mobile body is not present on a navigation path from the current position of the autonomous mobile body to the first target position, when an environmental object is detected based on position information newly obtained by the sensor when the autonomous mobile body is moving on the navigation path from the current position to the first target position, the collision avoider stops at least one of movement or rotation that changes a travel direction, the movement and the rotation being caused by the move mechanism in a direction in which the autonomous mobile body possibly collides with the environmental object detected. When the collision avoider stops at least one of the movement or the rotation, the controller generates a second target position in a direction in which the autonomous mobile body is able to move from the current position, and controls the move mechanism to cause the autonomous mobile body to move to the first target position after moving from the current position to the second target position.

In order to provide a control method performed by such an autonomous mobile body, a control method performed by an autonomous mobile body according to an aspect of the present disclosure is a control method performed by an autonomous mobile body that controls traveling of the autonomous mobile body and includes a move mechanism and a sensor that obtains position information of an environmental object present in vicinity of the autonomous mobile body, the control method including: based on the position information obtained, successively generating a first target position on a navigation path from a current position of the autonomous mobile body to a final target position to result in successively generated first target positions, and controlling the move mechanism to cause the autonomous mobile body to reach the final target position by tracking the successively generated first target positions. The controlling includes: in a case where, based on the position information obtained, a no-entry region for the autonomous mobile body is not present on a navigation path from the current position of the autonomous mobile body to the first target position, when an environmental object is detected based on position information newly obtained by the sensor when the autonomous mobile body is moving on the navigation path from the current position to the first target position, stopping at least one of movement or rotation that changes a travel direction, the movement and the rotation being caused by the move mechanism in a direction in which the autonomous mobile body possibly collides with the environmental object detected. When at least one of the movement or the rotation is stopped in the stopping, in the controlling, a second target position is generated in a direction in which the autonomous mobile body is able to move from the current position, and the move mechanism is controlled to cause the autonomous mobile body to move to the first target position after moving from the current position to the second target position.

### Advantageous Effects

The present disclosure provides, for instance, an autonomous mobile body that can move from the current position to the final target position even when an environment in which the autonomous mobile body travels is complicated.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1

FIG. 1 is a block diagram illustrating a configuration of an autonomous mobile body according to an embodiment.

FIG. 2

FIG. 2 is an image diagram when sensors obtain position information of an environmental object present in the vicinity thereof.

FIG. 3

FIG. 3 includes schematic diagrams when the autonomous mobile body generates a navigation path from the current position to a final target position and moves along the generated navigation path.

FIG. 4

FIG. 4 includes schematic diagrams for explaining an obstacle avoidance function achieved by an obstacle avoider.

FIG. 5A

FIG. 5A includes schematic diagrams for explaining a collision avoidance function achieved by a collision avoider.

FIG. 5B

FIG. 5B includes schematic diagrams illustrating specific examples when the autonomous mobile body moves to a first target position from the state in (b) of FIG. 5A.

FIG. 6

FIG. 6 is a flowchart showing operation performed by the autonomous mobile body according to the embodiment.

FIG. 7

FIG. 7 includes schematic diagrams showing an example of a path along which the autonomous mobile body travels to reach the first target position when it is determined that the collision avoider has stopped a move mechanism using the collision avoidance function.

FIG. 8

FIG. 8 is a schematic diagram for explaining Variation 1 when a controller generates a second target position.

FIG. 9

FIG. 9 is a schematic diagram for explaining Variation 2 when the controller generates the second target position.

### DESCRIPTION OF EMBODIMENTS

### Knowledge Acquired by Inventor

An autonomous mobile body according to PTL 1 may not be able to move from the current position to the final target position. For example, when a first target position is generated on a navigation path and a no-entry region for the autonomous mobile body is not present on a navigation path from the current position of the autonomous mobile body to the first target position, the autonomous mobile body starts moving to the first target position. When the autonomous mobile body starts moving to the first target position, in situations where rotation that changes the travel direction is necessary in order to move to the first target position, in a case where an environmental object such as a wall is present in the vicinity of the autonomous mobile body although a no-entry region for the autonomous mobile body is not present on the navigation path from the current position of the autonomous mobile body to the first target position, it is necessary to stop the rotation in order to avoid collision with the wall, for instance. However, when the first target position is not located, due to the stopping of the rotation, on a straight-line course with reference to the travel direction of the autonomous mobile body, the autonomous mobile body may not be able to move to the first target position. Thus, when a first target position is generated on a navigation path and a no-entry region for the autonomous mobile body is not present on a navigation path from the current position of the autonomous mobile body to the first target position, the autonomous mobile body cannot move to the first target position or rotate to change the travel direction, and may become immovable.

To address these, the inventor diligently examined to find methods that allow an autonomous mobile body to move from the current position to the final target position even in a complicated circumstance in the traveling of the autonomous mobile body. As a result, the inventor conceived an autonomous mobile body that can escape from an immovable state by generating a second target position different from the first target position, when the autonomous mobile body cannot move to the first target position or rotate to change the travel direction. Accordingly, the inventor considered that the autonomous mobile body can move from the current position to the final target position even when an environment in which the autonomous mobile body travels is complicated.

More specifically, an autonomous mobile body according to a first aspect of the present disclosure is an autonomous mobile body that includes a move mechanism, the autonomous mobile body including: a sensor that obtains position information of an environmental object present in vicinity of the autonomous mobile body; and a controller that, based on the position information obtained, successively generates a first target position on a navigation path from a current position of the autonomous mobile body to a final target position to result in successively generated first target positions, and controls the move mechanism to cause the autonomous mobile body to reach the final target position by tracking the successively generated first target positions. The controller includes a collision avoider. In a case where, based on the position information obtained, a no-entry region for the autonomous mobile body is not present on a navigation path from the current position of the autonomous mobile body to the first target position, when an environmental object is detected based on position information newly obtained by the sensor when the autonomous mobile body is moving on the navigation path from the current position to the first target position, the collision avoider stops at least one of movement or rotation that changes a travel direction, the movement and the rotation being caused by the move mechanism in a direction in which the autonomous mobile body possibly collides with the environmental object detected. When the collision avoider stops at least one of the movement or the rotation, the controller generates a second target position in a direction in which the autonomous mobile body is able to move from the current position, and controls the move mechanism to cause the autonomous mobile body to move to the first target position after moving from the current position to the second target position.

Accordingly, the autonomous mobile body newly generates the second target position in a direction in which the autonomous mobile body can move from the current position when the collision avoider stops at least one of movement or rotation. Thus, the autonomous mobile body can escape from the immovable state by first passing through the second target position and then moving to the first target position. As a result, the autonomous mobile body can move from the current position to the final target position even when an environment in which the autonomous mobile body travels is complicated.

An autonomous mobile body according to a second aspect is the autonomous mobile body according to the first aspect in which the controller generates the second target position ahead of the autonomous mobile body when the first target position is in a forward region ahead of the autonomous mobile body with reference to a rotation center of the autonomous mobile body, and generates the second target position behind the autonomous mobile body when the first target position is in a rearward region behind the autonomous mobile body with reference to the rotation center of the autonomous mobile body.

Accordingly, the autonomous mobile body can generate the second target position in the same region as the region where the first target position is located when a region is divided into regions located ahead of and behind the autonomous mobile body with reference to the rotation center of the autonomous mobile body. Thus, the autonomous mobile body can shorten the distance to move to the first target position via the second target position, and thus can reduce time for escaping from the immovable state and power consumption of the autonomous mobile body.

An autonomous mobile body according to a third aspect is the autonomous mobile body according to the second aspect in which the controller generates the second target position to cause a distance from the current position of the autonomous mobile body to the second target position to match a preset distance.

Accordingly, the autonomous mobile body generates the second target position to cause the distance from the current position to the second target position to match a preset distance, and thus can readily determine, as the second target position, a position sufficiently distant from the detected environmental object without requiring complicated calculation. Thus, after moving to the second target position, the autonomous mobile body can make movement toward the first target position and rotation that changes the travel direction without colliding with the detected environmental object. As a result, the autonomous mobile body can escape from the immovable state and move from the current position to the final target position.

An autonomous mobile body according to a fourth aspect is the autonomous mobile body according to the second aspect in which when the collision avoider stops at least one of the movement or the rotation, the controller calculates a movable distance over which the autonomous mobile body is able to move without entering the no-entry region in a current travel direction of the autonomous mobile body, and generates the second target position to cause a distance from the current position of the autonomous mobile body to the second target position to match the movable distance calculated.

Accordingly, the autonomous mobile body can set, as the second target position, a position sufficiently distant from a detected environmental object, where no environmental object is present in the vicinity thereof. Thus, after moving to the second target position, the autonomous mobile body can make movement toward the first target position and rotation that changes the travel direction without colliding with the detected environmental object or another environmental object. As a result, the autonomous mobile body can escape from the immovable state and move from the current position to the final target position.

An autonomous mobile body according to a fifth aspect is the autonomous mobile body according to the first aspect in which the controller generates the second target position in one direction among a forward direction and a rearward direction from the autonomous mobile body, the one direction having a longer distance over which the autonomous mobile body is able to move without entering the no-entry region from the current position.

Accordingly, the autonomous mobile body can generate the second target position at a spot in a forward or rearward direction of the autonomous mobile body, which is more distant from the detected environmental object and where no environmental object is present in the vicinity thereof. Thus, after moving to the second target position, the autonomous mobile body can make movement toward the first target position and rotation that changes the travel direction without colliding with the detected environmental object or another environmental object. As a result, the autonomous mobile body can escape from the immovable state and move from the current position to the final target position.

An autonomous mobile body according to a sixth aspect is the autonomous mobile body according to the fifth aspect in which the controller generates the second target position to cause a distance from the current position of the autonomous mobile body to the second target position to match a preset distance.

Accordingly, the autonomous mobile body generates the second target position to cause the distance from the current position to the second target position to match a preset distance, and thus can readily determine, as the second target position, a position sufficiently distant from the detected environmental object without requiring complicated calculation. Thus, after moving to the second target position, the autonomous mobile body can make movement toward the first target position and rotation that changes the travel direction without colliding with the detected environmental object. As a result, the autonomous mobile body can escape from the immovable state and move from the current position to the final target position.

An autonomous mobile body according to a seventh aspect is the autonomous mobile body according to the fifth aspect in which when the collision avoider stops at least one of the movement or the rotation, the controller calculates a movable distance over which the autonomous mobile body is able to move without entering the no-entry region in a current travel direction of the autonomous mobile body, and generates the second target position to cause a distance from the current position of the autonomous mobile body to the second target position to match the movable distance calculated.

Accordingly, the autonomous mobile body can set, as the second target position, a position sufficiently distant from a detected environmental object, where no environmental object is present in the vicinity thereof. Thus, after moving to the second target position, the autonomous mobile body can make movement toward the first target position and rotation that changes the travel direction without colliding with the detected environmental object or another environmental object. As a result, the autonomous mobile body can escape from the immovable state and move from the current position to the final target position.

An autonomous mobile body according to an eighth aspect is the autonomous mobile body according to any one of the first to seventh aspects in which while the autonomous mobile body is moving to the second target position, at a point in time when the first target position is in an opposite direction and is in a region between a first center line and a second center line, the controller controls the move mechanism to cause the autonomous mobile body to stop moving to the second target position and move to the first target position, the opposite direction being opposite the travel direction of the autonomous mobile body with reference to a rotation center of the autonomous mobile body, the first center line extending in a direction that coincides with a current travel direction of the autonomous mobile body and passing through the rotation center of the autonomous mobile body, the second center line resulting from rotating the first center line by a predetermined angle about the rotation center of the autonomous mobile body as a center point.

Accordingly, at a point in time when the first target position is in the opposite direction of the travel direction of the autonomous mobile body and is in a region between the first center line and the second center line, the autonomous mobile body stops moving to the second target position and moves to the first target position. Thus, the autonomous mobile body can further shorten the distance to move to the first target position after once moving in the direction in which the autonomous mobile body can move from the current position, and thus can reduce time for escaping from the immovable state and power consumption of the autonomous mobile body.

An autonomous mobile body according to a ninth aspect is the autonomous mobile body according to any one of the first to seventh aspects in which when the collision avoider stops the rotation, the controller generates the second target position in an opposite direction of a direction in which the autonomous mobile body makes the rotation, with reference to a first center line extending in a direction that coincides with a current travel direction of the autonomous mobile body and passing through a rotation center of the autonomous mobile body.

Accordingly, the autonomous mobile body generates the second target position in the opposite direction of the direction in which the autonomous mobile body rotates with reference to the first center line, and thus can reduce the amount of rotation when the travel direction is changed in order to move from the second target position to the first target position. Thus, the autonomous mobile body can minimize the load when moving from the second target position to the first target position.

An autonomous mobile body according to a tenth aspect is the autonomous mobile body according to any one of the first to seventh aspects in which the controller generates the second target position in a region between a first center line and a third center line, the first center line extending in a direction that coincides with a current travel direction of the autonomous mobile body and passing through a rotation center of the autonomous mobile body, the third center line extending in a direction that coincides with the travel direction of the autonomous mobile body when the autonomous mobile body reaches the first target position and passing through the rotation center of the autonomous mobile body.

Accordingly, since the autonomous mobile body generates the second target position within a region between the first center line and the third center line, the autonomous mobile body can reduce the amount of rotation when the travel direction is changed, in order to move from the second target position to the first target position. Thus, the autonomous mobile body can minimize the load when moving from the second target position to the first target position.

An autonomous mobile body according to an eleventh aspect is the autonomous mobile body according to the ninth or tenth aspect in which while the autonomous mobile body is moving to the second target position, at a point in time when the first target position is in an opposite direction and is in a region between the first center line and a second center line, the controller controls the move mechanism to cause the autonomous mobile body to stop moving to the second target position and move to the first target position, the opposite direction being opposite the travel direction of the autonomous mobile body with reference to the rotation center of the autonomous mobile body, the second center line resulting from rotating the first center line by a predetermined angle about the rotation center of the autonomous mobile body as a center point.

Accordingly, at a point in time when the first target position is in the opposite direction of the travel direction of the autonomous mobile body and is in a region between the first center line and the second center line, the autonomous mobile body stops moving to the second target position and moves to the first target position. Thus, the autonomous mobile body can further shorten the distance to move to the first target position after once moving in the direction in which the autonomous mobile body can move from the current position, and thus can reduce time for escaping from the immovable state and power consumption of the autonomous mobile body.

A control method performed by an autonomous mobile body according to a twelfth aspect is a control method performed by an autonomous mobile body that controls traveling of the autonomous mobile body and includes a move mechanism and a sensor that obtains position information of an environmental object present in vicinity of the autonomous mobile body, the control method including: based on the position information obtained, successively generating a first target position on a navigation path from a current position of the autonomous mobile body to a final target position to result in successively generated first target positions, and controlling the move mechanism to cause the autonomous mobile body to reach the final target position by tracking the successively generated first target positions. The controlling includes: in a case where, based on the position information obtained, a no-entry region for the autonomous mobile body is not present on a navigation path from the current position of the autonomous mobile body to the first target position, when an environmental object is detected based on position information newly obtained by the sensor when the autonomous mobile body is moving on the navigation path from the current position to the first target position, stopping at least one of movement or rotation that changes a travel direction, the movement and the rotation being caused by the move mechanism in a direction in which the autonomous mobile body possibly collides with the environmental object detected. When at least one of the movement or the rotation is stopped in the stopping, in the controlling, a second target position is generated in a direction in which the autonomous mobile body is able to move from the current position, and the move mechanism is controlled to cause the autonomous mobile body to move to the first target position after moving from the current position to the second target position.

Accordingly, according to the control method performed by the autonomous mobile body, the second target position is newly generated in a direction in which the autonomous mobile body can move from the current position when the collision avoider stops at least one of movement or rotation. Thus, according to the control method performed by the autonomous mobile body, the autonomous mobile body can escape from the immovable state by first passing through the second target position and then moving to the first target position. As a result, according to the control method performed by the autonomous mobile body, the autonomous mobile body can be moved from the current position to the final target position even when an environment in which the autonomous mobile body travels is complicated.

### Embodiment

Embodiments of the present disclosure will now be described in detail with reference to the drawings. It should be noted that the embodiments described below each show one particular example of the present disclosure. The numerical values, elements, the arrangement and connection of the elements, steps, the processing order of the steps, and display, for instance, described in the following embodiments are examples, and thus are not intended to limit the present disclosure. Furthermore, the drawings do not necessarily provide strictly accurate illustrations. Throughout the drawings, substantially the same elements are given the same reference numeral, and the overlapping description is omitted or simplified.

### Configuration of autonomous mobile body

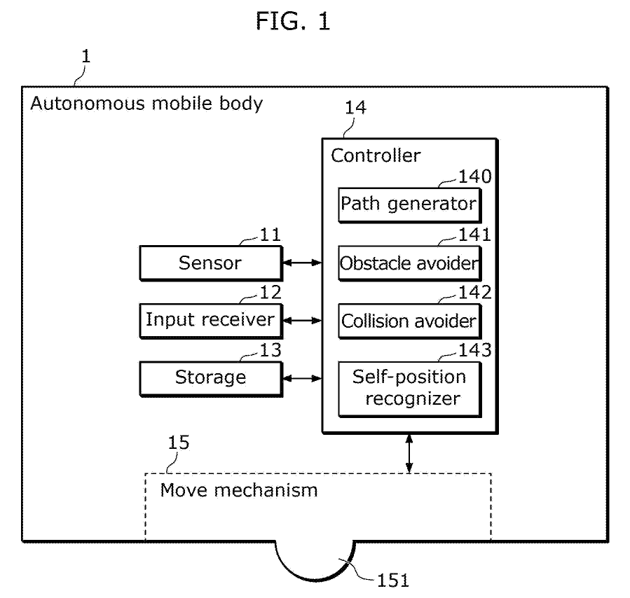

FIG. 1 is a block diagram illustrating a configuration of autonomous mobile body 1 according to an embodiment.

Autonomous mobile body 1 is a mobility device that travels from the current position (or stated differently, a start position) to a final target position. Autonomous mobile body 1 includes sensor 11, input receiver 12, storage 13, controller 14, and move mechanism 15.

Note that autonomous mobile body 1 may be a mobility device (a delivery robot) that has a structure that can accommodate items (such as food, beverages, and equipment, for example) and delivers the items to the final target position. Furthermore, autonomous mobile body 1 may be a mobility device (a delivery robot) that has a chair structure on which a person can sit, and delivers the person to the final target position. Autonomous mobile body 1 may be a cleaning robot, a security robot, or a facility guide robot, for instance, other than a delivery robot.

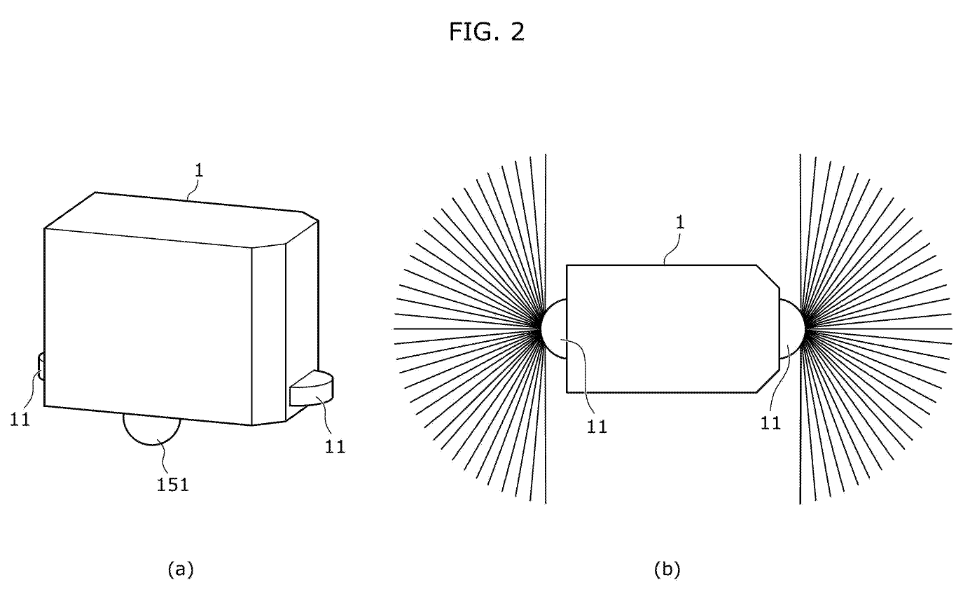

Sensor 11 obtains position information of an environmental object present in the vicinity of autonomous mobile body 1, and is a Light Detection and Ranging (LiDAR) sensor, for example. In the present embodiment, examples of an environmental object include immovable structures such as a wall and a column, other mobile bodies such as a person and a wheel chair, and movable obstacles such as a foliage plant and a baggage temporarily placed. FIG. 2 is an image diagram when sensors 11 obtain position information of an environmental object present in the vicinity thereof. Note that in FIG. 2 and the subsequent drawings, when schematic diagrams viewed from the upper surface of autonomous mobile body 1 are shown, the shape of autonomous mobile body 1 is illustrated in a hexagonal shape. Furthermore, in FIG. 2 and the subsequent drawings, autonomous mobile body 1 viewed from its upper surface is in a hexagonal shape tapered in the travel direction of autonomous mobile body 1 (that is, the orientation of the vehicle body), and thus indicates the travel direction. Specifically, when viewed from the direction facing sensor 11, a portion where surfaces (slanting surfaces viewed from the facing direction) different from a surface on which sensor 11 is attached (hereinafter, also referred to as a front surface) can be seen is on the front side of the vehicle body, and a portion where only a surface on which sensor 11 is attached (hereinafter, also referred to as a rear surface) can be seen is on the rear side of the vehicle body. Note that such a shape of autonomous mobile body 1 is not necessarily needed, and the front surface and the rear surface may be in the same shape. In the following description, when autonomous mobile body 1 moves straight ahead in the forward direction thereof, the movement may be referred to as forward movement, whereas when autonomous mobile body 1 moves straight toward the rear thereof, the movement may be referred to as rearward movement.

Part (a) of FIG. 2 is a schematic diagram when viewed from the lateral surface of autonomous mobile body 1. Part (b) of FIG. 2 is a schematic diagram when viewed from the upper surface of autonomous mobile body 1. Note that in (b) of FIG. 2, a plurality of lines extending radially from sensors 11 represent laser beams emitted by sensors 11 when sensors 11 are LiDAR sensors. In the following description, sensor 11 is assumed to be an LiDAR sensor.

As illustrated in (a) of FIG. 2, sensors 11 are provided on a center of a lower portion of the front surface of autonomous mobile body 1 and a center of a lower portion of the rear surface thereof, for example, and are configured using lasers that horizontally scan the travel surfaces in front and rear of autonomous mobile body 1.

As illustrated in (b) of FIG. 2, when horizontally scanning the travel surfaces in front and rear of autonomous mobile body 1, sensors 11 each obtain a distance to an environmental object in a semicircular region having a predetermined radius by oscillating a laser beam at a certain angle. For example, sensor 11 performs measurements every 0.5 degrees in a measurement range of 8 meters within ±90° to the left and right relative to the forward and rearward directions of autonomous mobile body 1. For example, sensor 11 intermittently performs scanning under a certain control cycle, and stores, into storage 13, a set of distance data obtained per scan as position information of an environmental object at each point in time. For example, autonomous mobile body 1 detects an environmental object and avoids collision with the environmental object, based on the position information of the environmental object obtained by sensor 11.

Note that the regions where sensors 11 horizontally scan the travel surfaces in front and rear of autonomous mobile body 1 are not limited to semicircular regions. Those regions may cover narrower-angle ranges or wider-angle ranges. Sensors 11 may be implemented using sensors that obtain position information of an environmental object present in the vicinity of autonomous mobile body 1 with use of ultrasonic waves or infrared light, for instance, or may be implemented using cameras that capture images in the vicinity of autonomous mobile body 1 and obtain position information of an environmental object present in the vicinity of autonomous mobile body 1 by processing the obtained images.

Returning to explanation with reference to FIG. 1, input receiver 12 receives input from a user of autonomous mobile body 1, for example. For example, input receiver 12 receives input of, for instance, a final target position of autonomous mobile body 1. Input receiver 12 is implemented using a touch panel, a keyboard and a mouse, or a wireless signal receiver, for example.

Storage 13 is a storage device that stores therein, for instance, a control program executed by controller 14. Other than the control program, storage 13 stores therein, for example, position information of an environmental object obtained by sensor 11, current position information of autonomous mobile body 1 obtained by self-position recognizer 143 described later, and map information indicating a region where autonomous mobile body 1 can travel. For example, when the region where autonomous mobile body 1 travels is inside a building, the map information includes position information of a wall and a column forming the building, a room inside the building, and a passageway, for instance.

Based on a final target position received by input receiver 12 and the current position of autonomous mobile body 1 recognized by self-position recognizer 143 described later, controller 14 generates a navigation path from the current position of autonomous mobile body 1 to the final target position. Controller 14 controls move mechanism 15 to cause autonomous mobile body 1 to reach the final target position, taking into consideration position information of an environmental object obtained by sensor 11.

Controller 14 is implemented using a microcomputer, for example, but may be implemented by using a processor. Functions of controller 14 are implemented by, for example, the microcomputer or the processor executing the control program stored in storage 13. Controller 14 includes path generator 140, obstacle avoider 141, collision avoider 142, and self-position recognizer 143.

Path generator 140 generates a path from the current position of autonomous mobile body 1 to the final target position and successively generates a first target position. When autonomous mobile body 1 moves by tracking the first target positions generated by path generator 140, in a case where a no-entry region for autonomous mobile body 1 is present on the navigation path, which is recognized in the vicinity of the environmental object detected by sensor 11, obstacle avoider 141 generates a detour point for avoiding such a region. Furthermore, obstacle avoider 141 controls move mechanism 15 to cause autonomous mobile body 1 to head for the generated detour point and move to the final target position by tracking the first target positions. Note that in the following description, generation of a detour point by obstacle avoider 141 and controlling move mechanism 15 to cause autonomous mobile body 1 to head for the generated detour point and move to the final target position by tracking the first target positions may be stated as an obstacle avoidance function.

Collision avoider 142 stops movement caused by move mechanism 15 in a direction in which autonomous mobile body 1 possibly collides with an environmental object detected by sensor 11 and rotation that changes the travel direction and is caused by move mechanism 15, when autonomous mobile body 1 moves along the navigation path generated by controller 14. Note that in the following description, collision avoider 142 stopping movement caused by move mechanism 15 in a direction in which collision with a detected environmental object may occur and rotation that changes the travel direction and is caused by move mechanism 15 may be stated as a collision avoiding function.

Self-position recognizer 143 processes position information of an environmental object stored in storage 13, and extracts structure information of, for instance, a wall or a column or a landmark, for instance, provided for position recognition. Such distinctive structure information and a distinctive landmark, for instance, are included in map information. Self-position recognizer 143 recognizes the position of autonomous mobile body 1 by comparing the extracted information and the map information, and obtains the current position information of autonomous mobile body 1. The current position information of autonomous mobile body 1 obtained by self-position recognizer 143 is stored into storage 13 and is appropriately referred to by controller 14.

Move mechanism 15 includes wheels 151, a motor that drives wheels 151, and a drive circuit that includes, for instance, a battery for supplying power to the motor.

Note that move mechanism 15 in the present embodiment adopts a drive system as follows. Move mechanism 15 includes two wheels 151 (drive wheels including a crawler), and enables, for instance, forward and rearward movement and on-the-spot rotation, through differential operation of two wheels 151. Specifically, when two wheels 151 are provided at opposite positions on the vehicle body of autonomous mobile body 1, autonomous mobile body 1 moves forward or rearward by move mechanism 15 driving two wheels 151 at the same speed in opposite directions. Furthermore, when two wheels 151 are provided at opposite positions on the vehicle body of autonomous mobile body 1, autonomous mobile body 1 rotates on the spot (about the rotation center) by move mechanism 15 driving two wheels 151 at the same speed in the same direction. Moreover, when two wheels 151 are provided at opposite positions on the vehicle body of autonomous mobile body 1, autonomous mobile body 1 moves curvilinearly in the forward or rearward direction by move mechanism 15 driving two wheels 151 at different speeds in opposite directions.

The axes of two wheels 151 of move mechanism 15 in the present embodiment do not rotate, and move mechanism 15 controls the rotation direction and the rotation amount of two wheels 151. Move mechanism 15 enables movement of autonomous mobile body 1 by controlling the rotation direction and the rotation amount of two wheels 151. In other words, autonomous mobile body 1 according to the present embodiment is assumed to be a mobility device that can move in the travel direction indicated by the shape of autonomous mobile body 1, but cannot move in directions different from the travel direction.

### Movement of autonomous mobile body

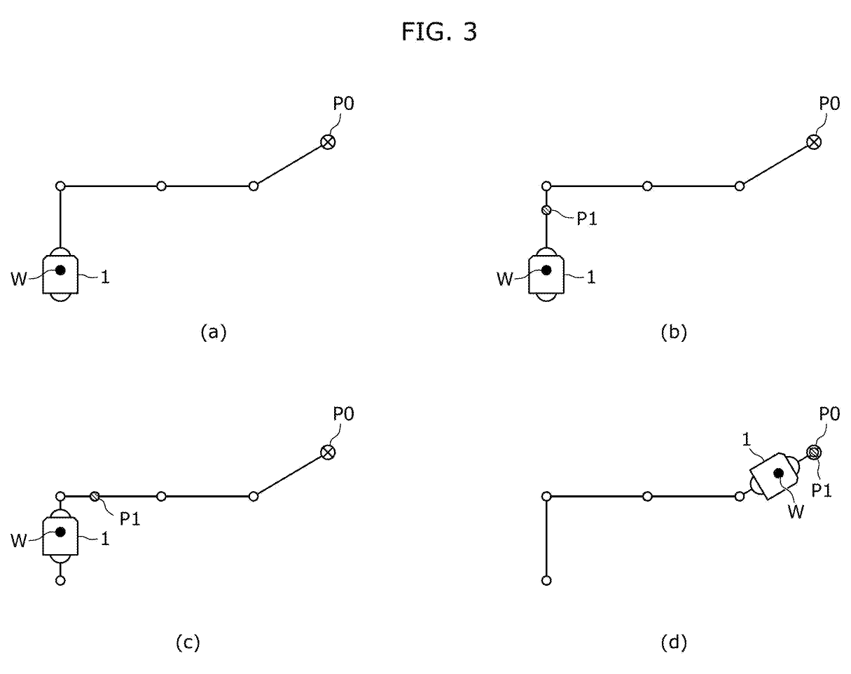

Next, an example in which when autonomous mobile body 1 travels from the current position to the final target position, controller 14 generates a navigation path from the current position of autonomous mobile body 1 to the final target position, and controls move mechanism 15 to cause autonomous mobile body 1 to reach the final target position is described. FIG. 3 includes schematic diagrams when autonomous mobile body 1 generates a navigation path from the current position to final target position P0 and moves along the generated navigation path. Note that in the description of FIG. 3, the current position of autonomous mobile body 1 is assumed to be rotation center W of autonomous mobile body 1.

Part (a) of FIG. 3 is a schematic diagram when controller 14 generates a navigation path from the current position of autonomous mobile body 1 to final target position P0.

In order to generate a navigation path from the current position of autonomous mobile body 1 to final target position P0, controller 14 generates a navigation path to final target position P0 by using, for instance, an A* algorithm, from nodes (white circles) and links defining the connection relations between the nodes, which are stored in storage 13. In (a) of FIG. 3, the navigation path generated by controller 14 is indicated by a line connecting the nodes to each other and to final target position P0.

Part (b) of FIG. 3 is a schematic diagram when controller 14 generates first target position P1 (a slashed circle) on the navigation path generated in (a) of FIG. 3.

Controller 14 generates first target position P1 on the navigation path generated in (a) of FIG. 3, at a spot at a certain distance from the current position of autonomous mobile body 1. For example, controller 14 generates first target position P1 in one of the semicircular regions illustrated in (b) of FIG. 2, on the navigation path generated in (a) of FIG. 3.

Part (c) of FIG. 3 is a schematic diagram when controller 14 controls move mechanism 15 to cause autonomous mobile body 1 to move to first target position P1 generated in (b) of FIG. 3.

Controller 14 controls move mechanism 15 to cause autonomous mobile body 1 to move from the current position of autonomous mobile body 1 in (b) of FIG. 3 to first target position P1 generated in (b) of FIG. 3. At this time, controller 14 controls move mechanism 15 to cause rotation center W of autonomous mobile body 1 to be on the navigation path.

Furthermore, controller 14 generates first target position P1 on the navigation path generated in (a) of FIG. 3, at a spot at a certain distance from the current position of autonomous mobile body 1 in (c) of FIG. 3. As described above, controller 14 successively generates first target position P1 on the navigation path from the current position of autonomous mobile body 1 to final target position P0, and controls move mechanism 15 to cause autonomous mobile body 1 to reach final target position P0 by tracking generated first target positions P1. Note that controller 14 may generate next first target position P1 at the moment when a predetermined time has elapsed since generation of previous first target position P1 or at the moment when autonomous mobile body 1 reaches generated first target position P1.

Part (d) of FIG. 3 is a schematic diagram when controller 14 generates first target position P1 at final target position P0.

Controller 14 generates first target position P1 on the navigation path generated in (a) of FIG. 3, at a spot at a certain distance from the current position of autonomous mobile body 1 in (d) of FIG. 3. Then, controller 14 controls move mechanism 15 to cause autonomous mobile body 1 to move from the current position of autonomous mobile body 1 in (d) of FIG. 3 to first target position P1 generated in (d) of FIG. 3. In the example in (d) of FIG. 3, since first target position P1 and final target position P0 coincide, controller 14 determines that autonomous mobile body 1 has reached final target position P0 at the moment when rotation center W of autonomous mobile body 1 coincides first target position P1, and controls and causes move mechanism 15 to finish moving autonomous mobile body 1. The orientation of autonomous mobile body 1 that stops at target position P0 may be predesignated, and when not only the position but also the orientation of autonomous mobile body 1 coincides the predesignated orientation, controller 14 may determine that autonomous mobile body 1 has reached target position P0. In this manner, controller 14 enables autonomous mobile body 1 to move from the current position to final target position P0.

### Obstacle avoidance function

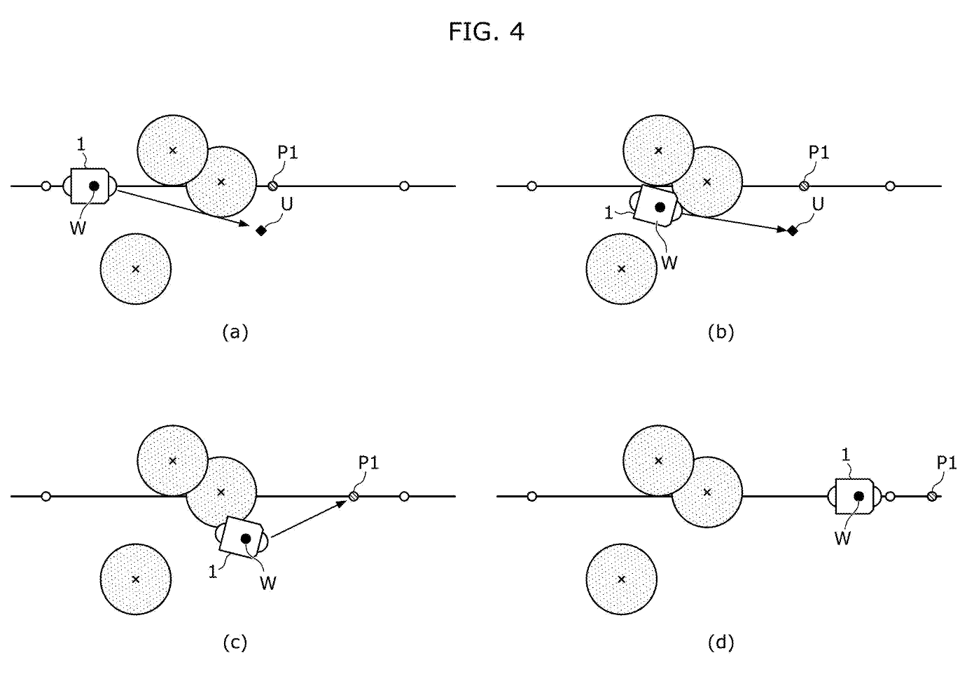

Next, an obstacle avoidance function achieved by obstacle avoider 141 is described. When autonomous mobile body 1 moves on a navigation path as described with reference to FIG. 3, in a case where a no-entry region for autonomous mobile body 1 is present on a navigation path from the current position of autonomous mobile body 1 to first target position P1, obstacle avoider 141 performs an obstacle avoidance function. FIG. 4 includes schematic diagrams for explaining the obstacle avoidance function achieved by obstacle avoider 141. Note that in the explanation of FIG. 4, a line that connects nodes (while circles) means a navigation path of autonomous mobile body 1 generated by path generator 140. Furthermore, a no-entry region for autonomous mobile body 1 is shown by dot hatching. In the present embodiment, a no-entry region for autonomous mobile body 1 is a region obtained by calculating a predetermined distance from the position of an environmental object (an X mark) detected by sensor 11 as a center. In the present embodiment, the no-entry region for autonomous mobile body 1 is a region where rotation center W of autonomous mobile body 1 should not be located.

Part (a) of FIG. 4 is a schematic diagram when obstacle avoider 141 generates detour point U.

Obstacle avoider 141 generates detour point U (a black diamond) when sensor 11 detects a no-entry region for autonomous mobile body 1, on the navigation path from the current position of autonomous mobile body 1 to first target position P1. Obstacle avoider 141 generates detour point U at a spot at a certain distance from the current position of autonomous mobile body 1, for example. Specifically, obstacle avoider 141 generates detour point U at a spot that does not overlap a no-entry region for autonomous mobile body 1, on the way to first target position P1 within one of the semicircular regions illustrated in (b) of FIG. 2. More specifically, obstacle avoider 141 generates detour point U to cause a straight line (represented by an arrow line) that connects the current position of autonomous mobile body 1 to detour point U to be a tangent to the no-entry region for autonomous mobile body 1.

Part (b) of FIG. 4 is a schematic diagram when obstacle avoider 141 controls move mechanism 15 to cause autonomous mobile body 1 to move to detour point U generated in (a) of FIG. 4.

Obstacle avoider 141 controls move mechanism 15 to cause autonomous mobile body 1 to move from the current position of autonomous mobile body 1 in (a) of FIG. 4 to detour point U generated in (a) of FIG. 4. At this time, obstacle avoider 141 controls move mechanism 15 to cause rotation center W of autonomous mobile body 1 to be present on a straight line between the current position of autonomous mobile body 1 in (a) of FIG. 4 and detour point U generated in (a) of FIG. 4, for example.

As illustrated in (b) of FIG. 4, obstacle avoider 141 generates next detour point U when sensor 11 detects a no-entry region for autonomous mobile body 1, on the navigation path from the current position of autonomous mobile body 1 to first target position P1 after autonomous mobile body 1 starts moving to detour point U. At this time, obstacle avoider 141 generates detour point U to cause a straight line (represented by an arrow line) that connects the current position of autonomous mobile body 1 to detour point U to be a tangent to the no-entry region for autonomous mobile body 1. As described above, obstacle avoider 141 generates detour point U until sensor 11 does not detect a no-entry region for autonomous mobile body 1, on the navigation path from the current position of autonomous mobile body 1 to first target position P1. Note that obstacle avoider 141 may generate next detour point U at a moment when a predetermined time has elapsed since generation of previous detour point U, or at a moment when autonomous mobile body 1 has reached generated detour point U.

Part (c) of FIG. 4 is a schematic diagram when autonomous mobile body 1 restarts moving to first target position P1.

Obstacle avoider 141 controls move mechanism 15 to cause autonomous mobile body 1 to move to first target position P1 when a no-entry region for autonomous mobile body 1 is not present on the navigation path from the current position of autonomous mobile body 1 in (c) of FIG. 4 to first target position P1 in (c) of FIG. 4.

Part (d) of FIG. 4 is a schematic diagram when autonomous mobile body 1 moves on the navigation path generated by controller 14.

Autonomous mobile body 1 restarts moving along the generated navigation path at a point in time when rotation center W of autonomous mobile body 1 is present on the navigation path generated by controller 14. In this manner, obstacle avoider 141 enables autonomous mobile body 1 to move from the current position to final target position P0 while avoiding an environmental object.

Note that to facilitate explanation, first target position P1 and detour point U are explained separately, but detour point U may be interpreted as first target position P1. Thus, a navigation path along which autonomous mobile body 1 moves while avoiding an environmental object corresponds to a navigation path from the current position of autonomous mobile body 1 to final target position P0.

### Collision avoidance function

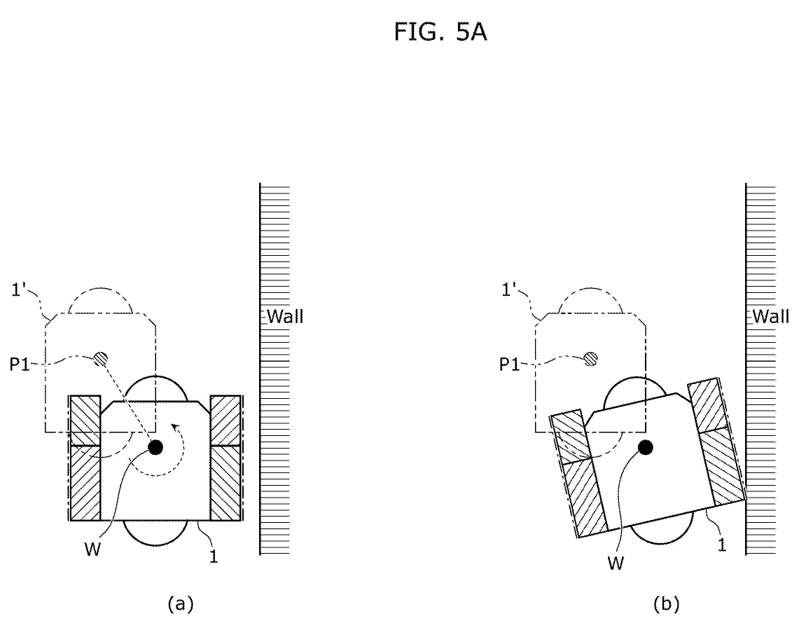

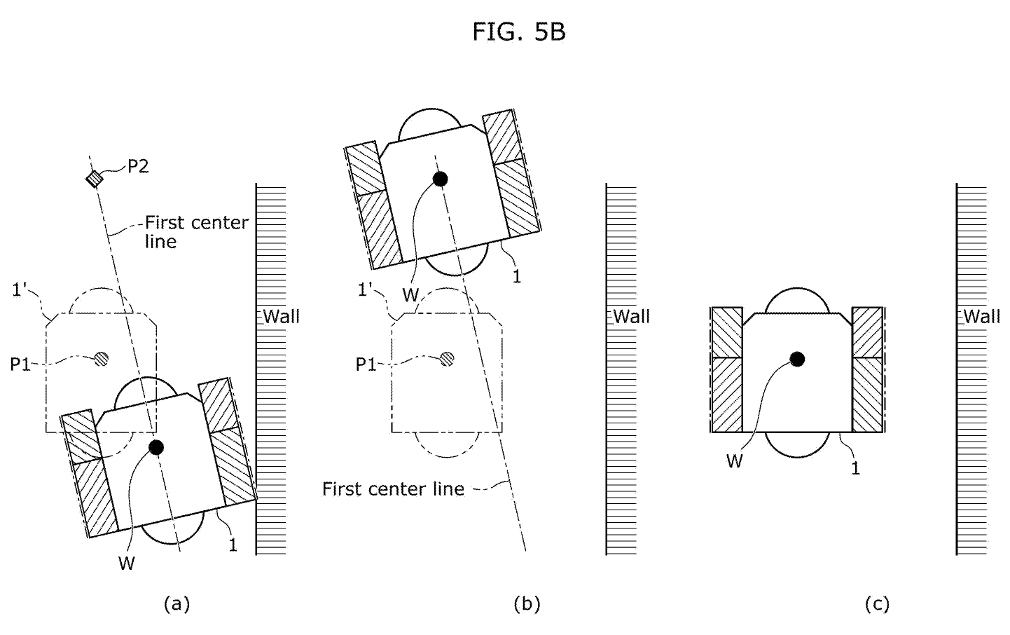

Next, a collision avoidance function achieved by collision avoider 142 is described. The collision avoidance function is a function to reduce the speed in the movement direction (including the rotational speed) according to the distance to a detected environmental object in the direction of movement (including rotation) and to stop before colliding with the environmental object. A sensor different from sensors 11 described above may be used to detect an environmental object at this time. FIG. 5A includes schematic diagrams for explaining the collision avoidance function achieved by collision avoider 142. Note that in FIG. 5A and the subsequent drawings, autonomous mobile body 1’ shown by dotted lines indicates to autonomous mobile body 1 at the expected stopped position and in the expected stopped orientation after autonomous mobile body 1 moves to first target position P1. In FIG. 5A and the subsequent drawings, regions between the lateral surfaces of the vehicle body of autonomous mobile body 1 and dash-dot lines (with negative-slope hatching and positive-slope hatching) are illustrated. For example, when an environmental object is present in a region illustrated with negative-slope hatching, left rotation (that is, counter-clockwise rotation) is prohibited, whereas an environmental object is present in a region illustrated with positive-slope hatching, right rotation (that is, clockwise rotation) is prohibited.

Part (a) of FIG. 5A is a schematic diagram illustrating an example when controller 14 generates first target position P1 on a navigation path from the current position of autonomous mobile body 1 to final target position P0. Note that in (a) of FIG. 5A, a wall is present on the right of autonomous mobile body 1.

Controller 14 generates first target position P1 diagonally forward to the left of autonomous mobile body 1. Controller 14 controls move mechanism 15 to cause autonomous mobile body 1 to move from the current position to first target position P1 since a no-entry region for autonomous mobile body 1 is not present on a navigation path from the current position of autonomous mobile body 1 to first target position P1. Controller 14 controls move mechanism 15 to cause autonomous mobile body 1 to rotate to the left so that the travel direction of autonomous mobile body 1 is directed to first target position P1 and then to move to first target position P1, for example.

Part (b) of FIG. 5A is a schematic diagram when collision avoider 142 stops rotation caused by move mechanism 15 when move mechanism 15 is rotating to change the travel direction from the state in (a) of FIG. 5A.

As illustrated in (b) of FIG. 5A, since one dash-dot line is in contact with the wall, an environmental object (that is, a wall) is detected in the region shown with negative-slope hatching, based on position information of the environmental object obtained by sensor 11. In such a case, collision avoider 142 stops rotation caused by move mechanism 15, in order to avoid collision with the detected environmental object. In this manner, collision avoider 142 can avoid collision with an environmental object present in the vicinity of autonomous mobile body 1.

However, when first target position P1 is not located, due to collision avoider 142 stopping rotation caused by move mechanism 15 as illustrated in (b) of FIG. 5A, on a straight-line course with reference to the travel direction of autonomous mobile body 1, autonomous mobile body 1 may not be able to move to first target position P1. Thus, it is considered that even when first target position P1 is generated on a navigation path and a no-entry region for autonomous mobile body 1 is not present on a navigation path from the current position of autonomous mobile body 1 to first target position P1, autonomous mobile body 1 cannot move to the first target position or rotate to change the travel direction, and may become immovable.

In view of this, the inventor conceived a method for autonomous mobile body 1 to escape from an immovable state even when autonomous mobile body 1 cannot move to first target position P1 or rotate to change the travel direction. FIG. 5B includes schematic diagrams illustrating specific examples when autonomous mobile body 1 moves to first target position P1 from the state in (b) of FIG. 5A.

Part (a) of FIG. 5B is a schematic diagram when controller 14 generates second target position P2 different from first target position P1.

Controller 14 generates second target position P2 in a direction in which autonomous mobile body 1 can move from the current position. Specifically, controller 14 generates second target position P2 on a first center line extending in a direction that coincides with the current travel direction of autonomous mobile body 1 (that is, the orientation of the vehicle body) and passing through rotation center W of autonomous mobile body 1, and controls move mechanism 15 to cause autonomous mobile body 1 to move from the current position to second target position P2.

Note that controller 14 may generate second target position P2 in a direction forward or rearward from autonomous mobile body 1 as long as second target position P2 is on the first center line. For example, controller 14 generates second target position P2 ahead of autonomous mobile body 1 when first target position P1 is in a forward region ahead of autonomous mobile body 1 with reference to rotation center W of autonomous mobile body 1 (corresponding to the example in (a) of FIG. 5B). Furthermore, controller 14 generates second target position P2 behind autonomous mobile body 1 when first target position P1 is in a rearward region behind autonomous mobile body 1 with reference to rotation center W of autonomous mobile body 1.

When generating second target position P2 on the first center line, controller 14 generates second target position P2 to cause the distance from the current position of autonomous mobile body 1 (or stated differently, rotation center W of autonomous mobile body 1) to second target position P2 to match a preset distance. For example, when controller 14 generates second target position P2 ahead of autonomous mobile body 1, controller 14 causes a total distance of predetermined distance α and the distance from rotation center W of autonomous mobile body 1 to sensor 11 attached to a center of a lower portion of the front surface of autonomous mobile body 1 to match a preset distance. Furthermore, when controller 14 generates second target position P2 behind autonomous mobile body 1, controller 14 causes a total distance of predetermined distance α and the distance from rotation center W of autonomous mobile body 1 to sensor 11 attached to a center of a lower portion of the rear surface of autonomous mobile body 1 to match a preset distance.

Part (b) of FIG. 5B is a schematic diagram when autonomous mobile body 1 reaches second target position P2 from the state in (a) of FIG. 5B.

As illustrated in (b) of FIG. 5B, by reaching second target position P2, autonomous mobile body 1 can make a region where a wall (an environmental object) that has caused collision avoider 142 to stop rotation caused by move mechanism 15 is not present, between autonomous mobile body 1 and the wall in (b) of FIG. 5A. Stated differently, even when move mechanism 15 causes at least one of movement or rotation that changes the travel direction in order that autonomous mobile body 1 moves from second target position P2 to first target position P1, autonomous mobile body 1 moves to a position (that is, second target position P2) at which collision avoider 142 does not stop the movement or rotation. Thus, controller 14 can control move mechanism 15 to cause autonomous mobile body 1 to move from second target position P2 to first target position P1.

Part (c) of FIG. 5B is a schematic diagram when autonomous mobile body 1 reaches first target position P1 from the state in (b) of FIG. 5B.

Controller 14 controls move mechanism 15 to cause autonomous mobile body 1 to be in the position of autonomous mobile body 1’ shown by the dotted line illustrated in (a) of FIG. 5B. In this manner, even when movement to first target position P1 or rotation that changes the travel direction cannot be made, controller 14 can control move mechanism 15 to cause autonomous mobile body 1 to escape from an immovable state and reach first target position P1.

Autonomous mobile body 1 can generate second target position P2 in the same region as the region where first target position P1 is located when a region is divided into regions located ahead of and behind autonomous mobile body 1 with reference to rotation center W of autonomous mobile body 1. Thus, autonomous mobile body 1 can shorten the distance to move to first target position P1 via second target position P2, and thus can reduce time for escaping from the immovable state and power consumption of autonomous mobile body 1.

Autonomous mobile body 1 generates second target position P2 to cause the distance from the current position to second target position P2 to match a preset distance, and thus can readily determine, as second target position P2, a position sufficiently distant from the detected environmental object without requiring complicated calculation. Thus, after moving to second target position P2, autonomous mobile body 1 can make movement toward first target position P1 and rotation that changes the travel direction without colliding with the detected environmental object. As a result, autonomous mobile body 1 can escape from the immovable state and move from the current position to final target position P0.

### Operation of autonomous mobile body

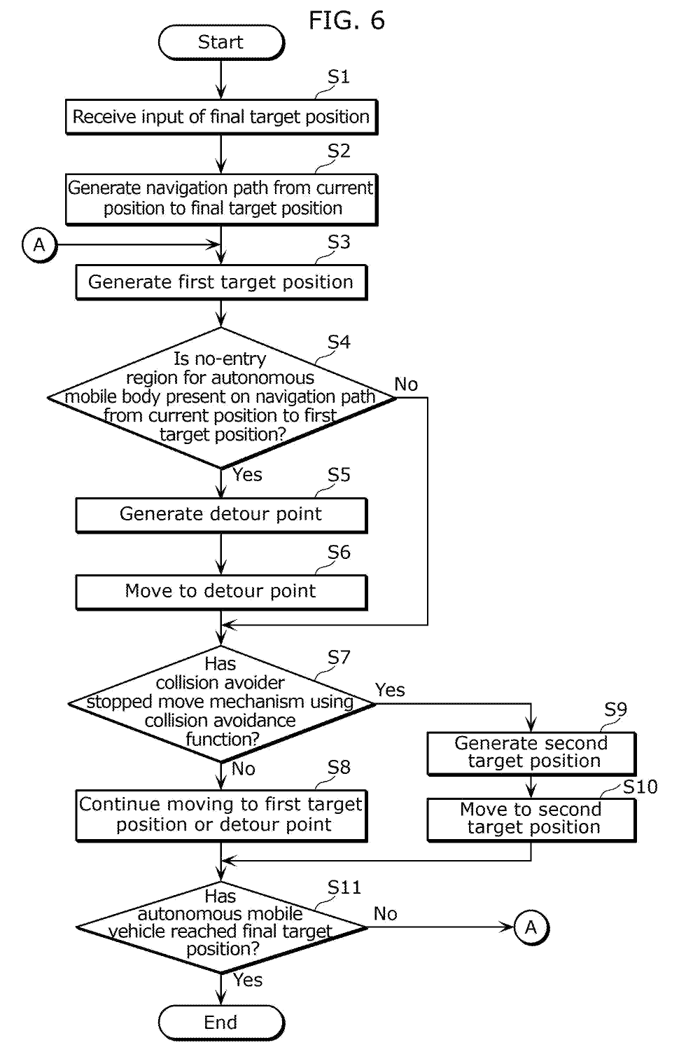

FIG. 6 is a flowchart showing operation performed by autonomous mobile body 1 according to the embodiment (that is, a control method performed by the autonomous mobile body). FIG. 6 is a flowchart showing operation (that is, control steps) executed when autonomous mobile body 1 moves from the current position to final target position P0.

Input receiver 12 receives input of final target position P0 input by a user of autonomous mobile body 1 (S1).

Based on the current position of autonomous mobile body 1 obtained by self-position recognizer 143 and final target position P0 received by input receiver 12 in step S1, controller 14 generates a navigation path from the current position of autonomous mobile body 1 to final target position P0 (S2). Controller 14 generates first target position P1 on the navigation path generated in step S2, at a spot at a certain distance from the current position of autonomous mobile body 1 (S3).

Obstacle avoider 141 determines whether a no-entry region for autonomous mobile body 1 is present on a navigation path from the current position to first target position P1 (S4). Stated differently, obstacle avoider 141 determines whether a no-entry region for autonomous mobile body 1 is present on the navigation path extending from the current position to first target position P1 and recognized in the vicinity of an environmental object detected by sensor 11.

When it is determined that a no-entry region for autonomous mobile body 1 is not present on the navigation path (No in S4), obstacle avoider 141 does not perform an obstacle avoidance function, and the processing transitions to step S7 described later.

When it is determined that a no-entry region for autonomous mobile body 1 is present on the navigation path (Yes in S4), obstacle avoider 141 generates detour point U at a spot on the way to first target position P1, which does not overlap the no-entry region for autonomous mobile body 1 (S5). Then, obstacle avoider 141 controls move mechanism 15 to cause autonomous mobile body 1 to move to detour point U generated in step S5, and autonomous mobile body 1 moves to detour point U (S6). Note that steps S5 and S6 correspond to the obstacle avoidance function.

Controller 14 determines whether collision avoider 142 has stopped move mechanism 15 using the collision avoidance function when autonomous mobile body 1 moves to first target position P1 or to detour point U (S7).

When controller 14 determines that collision avoider 142 has not stopped move mechanism 15 using the collision avoidance function (No in S7), controller 14 controls move mechanism 15 to cause autonomous mobile body 1 to continue moving to first target position P1 or detour point U (S8).

When controller 14 determines that collision avoider 142 has stopped move mechanism 15 using the collision avoidance function (Yes in S7), controller 14 generates second target position P2 on a first center line extending in a direction that coincides with the current travel direction of autonomous mobile body 1 and passing through rotation center W of autonomous mobile body 1 (S9). Then, controller 14 controls move mechanism 15 to cause autonomous mobile body 1 to move to second target position P2 generated in step S9, and autonomous mobile body 1 moves to second target position P2 (S10).

Controller 14 determines whether autonomous mobile body 1 has reached final target position P0 received by input receiver 12 in step S1, based on the current position of autonomous mobile body 1 obtained by self-position recognizer 143 (S11).

When controller 14 determines that autonomous mobile body 1 has not reached first target position P1 (No in S11), controller 14 executes the processing in step S3 again.

When controller 14 determines that autonomous mobile body 1 has reached first target position P1 (Yes in S11), controller 14 controls and causes move mechanism 15 to finish moving autonomous mobile body 1.

### Variation when autonomous mobile body reaches first target position via second target position

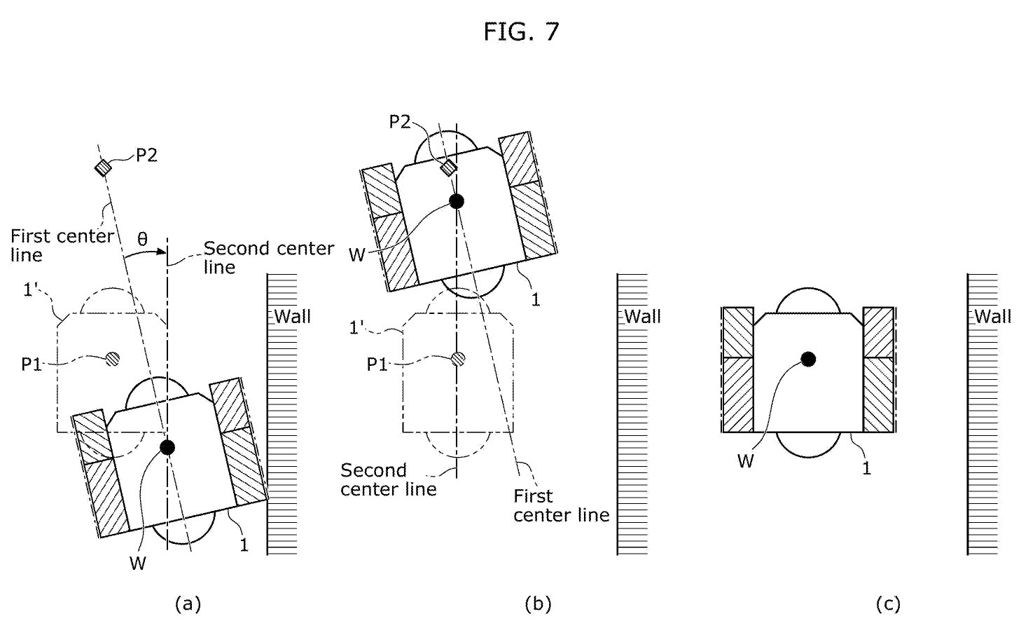

In the explanation of FIG. 5B above, an example in which controller 14 controls move mechanism 15 to cause autonomous mobile body 1 to reach second target position P2 and thereafter move to first target position P1 is described, but nevertheless controller 14 may control move mechanism 15 to move to first target position P1 by autonomous mobile body 1 following a route different from the above. Specifically, controller 14 may control move mechanism 15 to cause autonomous mobile body 1 to move to first target position P1 before reaching second target position P2. FIG. 7 includes schematic diagrams showing an example of a path along which autonomous mobile body 1 travels to reach first target position P1 when it is determined that collision avoider 142 has stopped move mechanism 15 using the collision avoidance function.

Part (a) of FIG. 7 is a schematic diagram when controller 14 generates second target position P2 different from first target position P1. Note that (a) of FIG. 7 is a schematic diagram after collision avoider 142 stops rotation caused by move mechanism 15 when move mechanism 15 is making a rotation that changes the travel direction from the state in (a) of FIG. 5A.

Controller sets a second center line different from the first center line when second target position P2 is generated. Specifically, controller 14 sets a second center line resulting from rotating the first center line by predetermined angle θ about rotation center W of autonomous mobile body 1 as a center point. Note that in the example in (a) of FIG. 7, move mechanism 15 is making a rotation to the left to change the travel direction of autonomous mobile body 1, and thus controller 14 sets a second center line resulting from rotating the first center line to the right by predetermined angle θ about rotation center W of autonomous mobile body 1 as a center point. For example, when move mechanism 15 is making a rotation to the right to change the travel direction of autonomous mobile body 1, controller 14 sets a second center line resulting from rotating the first center line to the left by predetermined angle θ about rotation center W of autonomous mobile body 1 as a center point.

Part (b) of FIG. 7 is a schematic diagram when autonomous mobile body 1 restarts moving to second target position P2.

As illustrated in (b) of FIG. 7, autonomous mobile body 1 has not yet reached second target position P2, but first target position P1 is present in a region between the first center line and the second center line. Stated differently, when autonomous mobile body 1 is moving to second target position P2, first target position P1 is present in an opposite direction of the travel direction of autonomous mobile body 1 with reference to rotation center W of autonomous mobile body 1 and first target position P1 is present in a region between the first center line and the second center line. At the point in time when the state as illustrated in (b) of FIG. 7 is reached, controller 14 controls move mechanism 15 to cause autonomous mobile body 1 to stop moving to second target position P2 and move to first target position P1.

Part (c) of FIG. 7 is a schematic diagram when autonomous mobile body 1 has reached first target position P1 from the state in (b) of FIG. 7.

Controller 14 controls move mechanism 15 to cause autonomous mobile body 1 to be in the position of autonomous mobile body 1’ shown by the dotted line illustrated in (a) of FIG. 7.

At a point in time when a state where autonomous mobile body 1 has not reached second target position P2 but first target position P1 is in a region between the first center line and the second center line is reached, controller 14 may control move mechanism 15 to cause autonomous mobile body 1 to stop moving to second target position P2 and move to first target position P1. Accordingly, controller 14 can shorten the distance over which autonomous mobile body 1 travels to first target position P1 after once moving in a direction in which autonomous mobile body 1 can move from the current position. Thus, autonomous mobile body 1 can reduce time for escaping from the immovable state and power consumption of autonomous mobile body 1.

Autonomous mobile body 1 may generate second target position P2 in an opposite direction of the direction in which autonomous mobile body 1 rotates, with reference to the first center line. Accordingly, autonomous mobile body 1 can reduce the amount of rotation when the travel direction is changed in order to move from second target position P2 to first target position P1. Thus, autonomous mobile body 1 can minimize the load when moving from second target position P2 to first target position P1.

### Variation when controller generates second target position

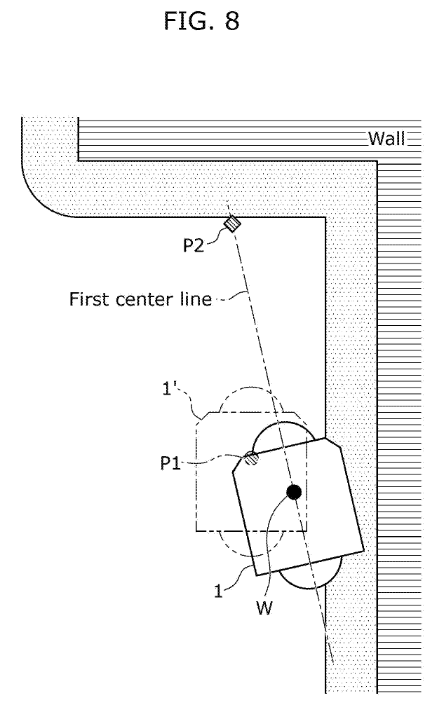

In the above explanation of FIG. 5B, an example in which controller 14 generates second target position P2 on the first center line to cause the distance from the current position of autonomous mobile body 1 to second target position P2 to match a preset distance is described, but the present embodiment is not limited thereto. For example, controller 14 may calculate a distance over which autonomous mobile body 1 can move without entering a no-entry region in the current travel direction of autonomous mobile body 1, and may generate second target position P2 to cause the distance from the current position of autonomous mobile body 1 to second target position P2 to match the calculated distance over which autonomous mobile body 1 can move. FIG. 8 is a schematic diagram for explaining Variation 1 when controller 14 generates second target position P2. FIG. 8 is a schematic diagram when controller 14 generates second target position P2 when collision avoider 142 performs the collision avoidance function.

Controller 14 calculates a distance over which autonomous mobile body 1 can move without entering a no-entry region in the current travel direction of autonomous mobile body 1. Controller 14 generates second target position P2 to cause the distance from the current position of autonomous mobile body 1 to second target position P2 to match the calculated distance over which autonomous mobile body 1 can move. Note that in the example in FIG. 8, controller 14 generates second target position P2 ahead of autonomous mobile body 1, but may generate second target position P2 behind autonomous mobile body 1 according to the situation. For example, when the distance over which autonomous mobile body 1 can move without entering a no-entry region is longer behind autonomous mobile body 1 than ahead of autonomous mobile body 1, controller 14 may generate second target position P2 behind autonomous mobile body 1.

Accordingly, autonomous mobile body 1 can set, as second target position P2, a position sufficiently distant from a detected environmental object (a wall in the example in FIG. 8), where no environmental object is present in the vicinity thereof. Thus, after moving to second target position P2, autonomous mobile body 1 can make movement toward first target position P1 and rotation that changes the travel direction without colliding with the detected environmental object or another environmental object. As a result, autonomous mobile body 1 can move from the current position to final target position P0.

Furthermore, autonomous mobile body 1 can generate second target position P2 at a spot in a forward or rearward direction, which is more distant from the detected environmental object and where no environmental object is present in the vicinity thereof. Thus, after moving to second target position P2, autonomous mobile body 1 can make movement toward first target position P1 and rotation that changes the travel direction without colliding with the detected environmental object or another environmental object. As a result, autonomous mobile body 1 can escape from the immovable state and move from the current position to final target position P0.

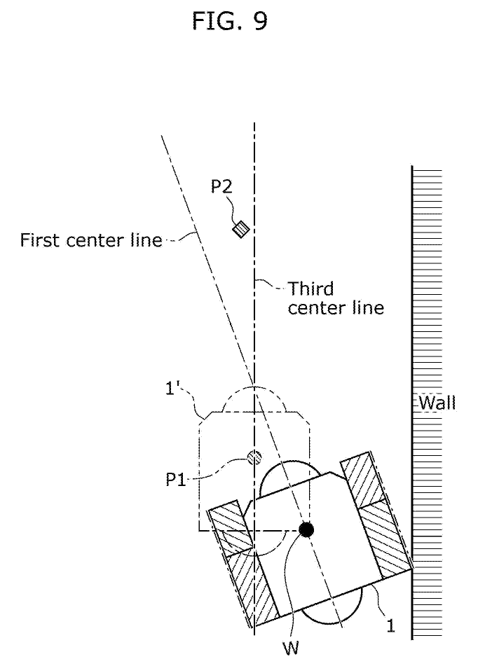

Controller 14 may generate second target position P2 at a spot other than on the first center line. FIG. 9 is a schematic diagram for explaining Variation 2 when controller 14 generates second target position P2. FIG. 9 is a schematic diagram when controller 14 generates second target position P2 when it is determined that collision avoider 142 has stopped move mechanism 15 using the collision avoidance function.

As illustrated in FIG. 9, controller 14 sets a third center line before generating second target position P2. Specifically, controller 14 sets, as a third center line, a line (i) extending in a direction that matches the travel direction of autonomous mobile body 1 (that is, the travel direction of autonomous mobile body 1’) when autonomous mobile body 1 moves to first target position P1 and (ii) passing through rotation center W of autonomous mobile body 1’. Controller 14 generates second target position P2 in a region between the first center line and the third center line after setting the third center line. Note that second target position P2 generated by controller 14 may be at any spot as long as the spot is within a region between the first center line and the third center line, and controller 14 may generate, as second target position P2, an intersection of the first center line and the third center line, for example.

Note that controller 14 may generate second target position P2 in the opposite direction of a direction of rotation stopped by collision avoider 142, with reference to the first center line without setting the third center line.

Accordingly, since autonomous mobile body 1 generates second target position P2 within a region between the first center line and the third center line, autonomous mobile body 1 can reduce the amount of rotation that changes the travel direction in order to move from second target position P2 to first target position P1. Thus, autonomous mobile body 1 can minimize the load when moving from second target position P2 to first target position P1.

As described above, autonomous mobile body 1 newly generates second target position P2 in a direction in which autonomous mobile body 1 can move from the current position when collision avoider 142 stops at least one of movement or rotation. Thus, autonomous mobile body 1 can escape from the immovable state by first passing through second target position P2 and then moving to first target position P1. As a result, autonomous mobile body 1 can move from the current position to final target position P0 even if an environment in which autonomous mobile body 1 travels is complicated.

The above description of the autonomous mobile body according to the present disclosure has been provided based on exemplary embodiments. However, the present disclosure is not limited to these embodiments. As long as the spirit of the present disclosure is not departed from, the present disclosure also encompasses embodiments resulting from adding, to the embodiments and variations, various modifications conceived by those skilled in the art, and embodiments obtained by combining elements in the embodiments.

For example, in the above embodiments, the processing executed by a specific processing unit may be executed by another processing unit. Furthermore, the order of processes may be changed, and the processes may also be executed in parallel.

For example, the order of processing described in the flowchart in the above embodiments is merely one example. The processing order of processes may be changed, and the processes may also be executed in parallel.

Furthermore, the general or specific aspects of the present disclosure may be implemented in systems, devices, methods, integrated circuits, computer programs, or computer-readable recording media such as CD-ROMs. In addition, the present disclosure may be implemented through any combination of systems, devices, methods, integrated circuits, computer programs, and recording media.

The present disclosure may be implemented as a control method for an autonomous mobile body executed by a computer, or as a program for causing a computer to execute such a control method. Moreover, the present disclosure may be implemented as a non-transitory computer-readable recording medium on which such a program is stored. The present disclosure may also be embodied as a program product that includes such a program.

### Industrial Applicability

An autonomous mobile body according to the present disclosure is applicable as a mobility device that travels from the current position to the final target position.

1. An autonomous mobile body that includes a move mechanism, the autonomous mobile body comprising:
a sensor that obtains position information of an environmental object present in vicinity of the autonomous mobile body; and
a controller that, based on the position information obtained, successively generates a first target position on a navigation path from a current position of the autonomous mobile body to a final target position to result in successively generated first target positions, and controls the move mechanism to cause the autonomous mobile body to reach the final target position by tracking the successively generated first target positions,
wherein the controller includes a collision avoider,
in a case where, based on the position information obtained, a no-entry region for the autonomous mobile body is not present on a navigation path from the current position of the autonomous mobile body to the first target position, when an environmental object is detected based on position information newly obtained by the sensor when the autonomous mobile body is moving on the navigation path from the current position to the first target position, the collision avoider stops at least one of movement or rotation that changes a travel direction, the movement and the rotation being caused by the move mechanism in a direction in which the autonomous mobile body possibly collides with the environmental object detected, and
when the collision avoider stops at least one of the movement or the rotation, the controller generates a second target position in a direction in which the autonomous mobile body is able to move from the current position, and controls the move mechanism to cause the autonomous mobile body to move to the first target position after moving from the current position to the second target position.

2. The autonomous mobile body according to claim 1,
wherein the controller generates the second target position ahead of the autonomous mobile body when the first target position is in a forward region ahead of the autonomous mobile body with reference to a rotation center of the autonomous mobile body, and generates the second target position behind the autonomous mobile body when the first target position is in a rearward region behind the autonomous mobile body with reference to the rotation center of the autonomous mobile body.

3. The autonomous mobile body according to claim 2,
wherein the controller generates the second target position to cause a distance from the current position of the autonomous mobile body to the second target position to match a preset distance.

4. The autonomous mobile body according to claim 2,
wherein when the collision avoider stops at least one of the movement or the rotation, the controller calculates a movable distance over which the autonomous mobile body is able to move without entering the no-entry region in a current travel direction of the autonomous mobile body, and generates the second target position to cause a distance from the current position of the autonomous mobile body to the second target position to match the movable distance calculated.

5. The autonomous mobile body according to claim 1,
wherein the controller generates the second target position in one direction among a forward direction and a rearward direction from the autonomous mobile body, the one direction having a longer distance over which the autonomous mobile body is able to move without entering the no-entry region from the current position.

6. The autonomous mobile body according to claim 5,
wherein the controller generates the second target position to cause a distance from the current position of the autonomous mobile body to the second target position to match a preset distance.

7. The autonomous mobile body according to claim 5,
wherein when the collision avoider stops at least one of the movement or the rotation, the controller calculates a movable distance over which the autonomous mobile body is able to move without entering the no-entry region in a current travel direction of the autonomous mobile body, and generates the second target position to cause a distance from the current position of the autonomous mobile body to the second target position to match the movable distance calculated.

8. The autonomous mobile body according to claim 1,
wherein while the autonomous mobile body is moving to the second target position, at a point in time when the first target position is in an opposite direction and is in a region between a first center line and a second center line, the controller controls the move mechanism to cause the autonomous mobile body to stop moving to the second target position and move to the first target position, the opposite direction being opposite the travel direction of the autonomous mobile body with reference to a rotation center of the autonomous mobile body, the first center line extending in a direction that coincides with a current travel direction of the autonomous mobile body and passing through the rotation center of the autonomous mobile body, the second center line resulting from rotating the first center line by a predetermined angle about the rotation center of the autonomous mobile body as a center point.

9. The autonomous mobile body according to claim 1,
wherein when the collision avoider stops the rotation, the controller generates the second target position in an opposite direction of a direction in which the autonomous mobile body makes the rotation, with reference to a first center line extending in a direction that coincides with a current travel direction of the autonomous mobile body and passing through a rotation center of the autonomous mobile body.

10. The autonomous mobile body according to claim 1,
wherein the controller generates the second target position in a region between a first center line and a third center line, the first center line extending in a direction that coincides with a current travel direction of the autonomous mobile body and passing through a rotation center of the autonomous mobile body, the third center line extending in a direction that coincides with the travel direction of the autonomous mobile body when the autonomous mobile body reaches the first target position and passing through the rotation center of the autonomous mobile body.

11. The autonomous mobile body according to claim 9,
wherein while the autonomous mobile body is moving to the second target position, at a point in time when the first target position is in an opposite direction and is in a region between the first center line and a second center line, the controller controls the move mechanism to cause the autonomous mobile body to stop moving to the second target position and move to the first target position, the opposite direction being opposite the travel direction of the autonomous mobile body with reference to the rotation center of the autonomous mobile body, the second center line resulting from rotating the first center line by a predetermined angle about the rotation center of the autonomous mobile body as a center point.

12. A control method performed by an autonomous mobile body that controls traveling of the autonomous mobile body and includes a move mechanism and a sensor that obtains position information of an environmental object present in vicinity of the autonomous mobile body, the control method comprising:
based on the position information obtained, successively generating a first target position on a navigation path from a current position of the autonomous mobile body to a final target position to result in successively generated first target positions, and controlling the move mechanism to cause the autonomous mobile body to reach the final target position by tracking the successively generated first target positions,
wherein the controlling includes: in a case where, based on the position information obtained, a no-entry region for the autonomous mobile body is not present on a navigation path from the current position of the autonomous mobile body to the first target position, when an environmental object is detected based on position information newly obtained by the sensor when the autonomous mobile body is moving on the navigation path from the current position to the first target position, stopping at least one of movement or rotation that changes a travel direction, the movement and the rotation being caused by the move mechanism in a direction in which the autonomous mobile body possibly collides with the environmental object detected, and
when at least one of the movement or the rotation is stopped in the stopping, in the controlling, a second target position is generated in a direction in which the autonomous mobile body is able to move from the current position, and the move mechanism is controlled to cause the autonomous mobile body to move to the first target position after moving from the current position to the second target position.
